(19) United States
(12) Patent Application Publication
(10) Pub. No.: US 2019/0187821 A1
(43) Pub. Date: Jun. 20, 2019

(54) INTERACTIVE PROJECTION SYSTEM, INTERACTIVE PROJECTOR AND METHOD OF CONTROLLING INTERACTIVE PROJECTOR

(71) Applicant: SEIKO EPSON CORPORATION, Tokyo (JP)

(72) Inventor: Reza PARSEH, Oslo (NO)

(73) Assignee: SEIKO EPSON CORPORATION, Tokyo (JP)

(21) Appl. No.: 16/219,068

(22) Filed: Dec. 13, 2018

(30) Foreign Application Priority Data
Dec. 14, 2017 (JP) 2017-239555

(51) Int. Cl. G06F 3/0354; G06F 3/0346; G06F 3/038; G06F 3/042; G06F 3/01; H04N 9/31

(52) U.S. Cl. CPC G06F 3/03545; G06F 3/0346; G06F 3/0383; G06F 3/005; G06F 3/017; H04N 9/31; G06F 3/0425

(57) ABSTRACT

An interactive projection system includes a pointing element having a first end portion used for a writing mode, and a second end portion used for an erasing mode, a projection section projecting an image on a screen surface in accordance with an input operation using the pointing element, a first camera taking an image of the pointing element, a second camera disposed at a different position from a position of the first camera and taking an image of the pointing element, a detection section adapted to detect a position on the screen surface pointed by the pointing element based on the first camera image and the second camera image, and a determination section adapted to determine whether an operation mode is the writing mode or the erasing mode based on a matching check between the first camera image or the second camera image and a template image.

### BACKGROUND

### 1. Technical Field

The present disclosure relates to an interactive projection system, an interactive projector and a method of controlling the interactive projector.

### 2. Related Art

JP-A-2013-175001 discloses the fact that a tool bar is displayed to allow the user to select a tool in the case of using an interactive projector in a whiteboard mode.

In such an interactive projector as in the related art document mentioned above, in the case in which the user selects a tool from the tool bar, when performing writing in a writing mode and then erasing the writing, for example, it is necessary to select an erasing mode from the tool bar and then perform erasing. However, the operation of performing the selection from the tool bar in each case as described above is bad in operability, and further, makes it difficult to intuitively figure out which tool is selected at present.

### SUMMARY

An advantage of some aspects of the present disclosure is to improve the operability of the selection between the writing mode and the erasing mode, and at the same time, to make it easy to intuitively figure out the operation mode.

An aspect of the present disclosure is directed to an interactive projection system including a pointing element having a first end portion which is one end portion in a longitudinal direction and is used for a writing mode, and a second end portion which is the other end portion and is used for an erasing mode; a projection section adapted to project an image on a screen surface in accordance with an input operation using the pointing element; a first camera adapted to take an image of the pointing element; a second camera disposed at a different position from a position of the first camera, and adapted to take an image of the pointing element; a detection section adapted to detect a position on the screen surface pointed by either one of the first end portion and the second end portion based on the image taken by the first camera and the image taken by the second camera; a storage section adapted to store a template image used to determine a posture of the pointing element to the screen surface; and a determination section adapted to determine whether an operation mode by the pointing element is the writing mode or the erasing mode based on a matching check between the image taken by at least either one of the first camera and the second camera and the template image stored in the storage section. According to this aspect, since it is sufficient for the user to use the first end portion in the case of attempting to use the system in the writing mode, or to use the second end portion in the case of attempting to use the system in the erasing mode, the operability of the selection between the writing mode and the erasing mode is good, and it is easy to intuitively figure out the operation mode.

In the aspect described above, the determination section may determine whether the operation mode by the pointing element is the writing mode or the erasing mode based on the images taken by the first camera and the second camera. According to the aspect with this configuration, the accuracy of the determination described above is improved.

The present disclosure can be implemented in a variety of aspects other than the aspects described above. The present disclosure can be implemented in such aspects as an interactive projector and a method of determining the operation mode.

### BRIEF DESCRIPTION OF THE DRAWINGS

The invention will be described with reference to the accompanying drawings, wherein like numbers reference like elements.

FIG. 1 is a perspective view of a projection system according to the invention.

FIG. 2 is a front view of the projection system.

FIG. 3 is a side view of the projection system.

FIG. 4 is a block diagram showing an internal configuration of a projector.

FIG. 5 is a diagram showing an example of a template image.

FIG. 6 is a diagram showing an example of the template image.

FIG. 7 is a diagram showing an example of the template image.

FIG. 8 is a diagram showing an example of the template image.

FIG. 9 is a diagram showing an example of the template image.

FIG. 10 is a diagram showing an example of the template image.

FIG. 11 is a diagram showing an example of the template image.

FIG. 12 is a diagram showing an example of the template image.

FIG. 13 is a diagram showing an example of the template image.

FIG. 14 is a diagram showing an example of a flowchart of an image projection process corresponding to operation mode determination.

### DESCRIPTION OF AN EXEMPLARY EMBODIMENT

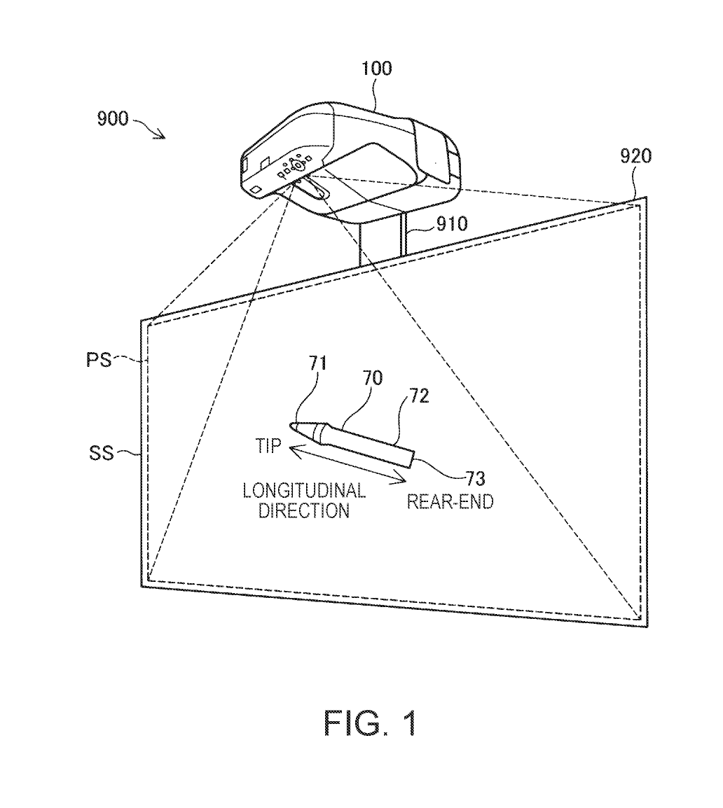

FIG. 1 is a perspective view of a projection system 900. The projection system 900 is an interactive projection system. The projection system 900 has a projector 100, a screen plate 920, and a pointing element 70. The projector 100 is an interactive projector.

A front surface of the screen plate 920 is used as a projection screen surface SS. The projector 100 is fixed in front of and above the screen plate 920 with a support member 910. It should be noted that although the projection screen surface SS is arranged so as to be perpendicular to a horizontal plane in FIG. 1, it is also possible to use the projection system 900 with the projection screen surface SS arranged horizontally.

The projector 100 projects a projected screen PS on the projection screen surface SS. The projected screen PS normally includes an image drawn in the projector 100. In the case in which the image drawn in the projector 100 does not exist, the projector 100 irradiates the projected screen PS with light to display, for example, a white image. In the present embodiment, the “projection screen surface SS” denotes a surface of a member on which the image is projected. Further, the “projected screen PS” denotes an area of an image projected on the projection screen surface SS by the projector 100. Normally, the projected screen PS is projected on a part of the projection screen surface SS. The projection screen surface SS is also used as an operation surface for performing pointing of a position with the pointing element 70, and is therefore also referred to as an “operation surface SS.”

The pointing element 70 is a pen-shaped pointing element having a tip portion 71 formed to have a taper shape, a sleeve section 72 held by the user, and a rear-end portion 73 formed to have a roughly flat shape. The tip portion 71 is a tip portion in the longitudinal direction of the pointing element 70, and is a first end portion. The rear-end portion 73 is a rear-end portion in the longitudinal direction of the pointing element 70, and is a second end portion.

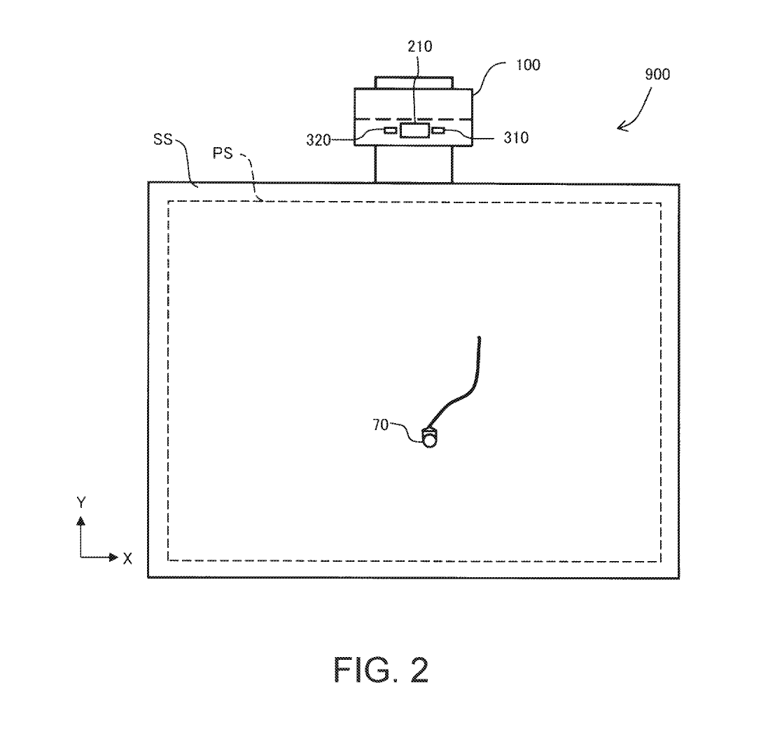

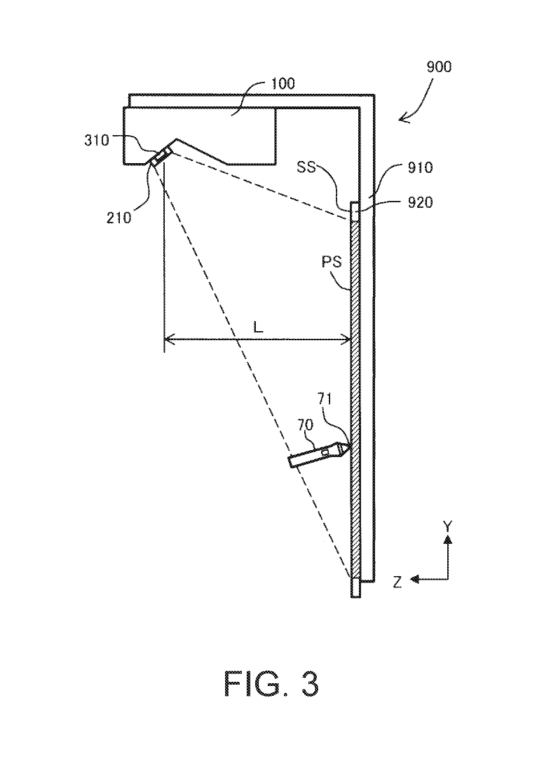

FIG. 2 is a front view of the projection system 900. FIG. 3 is a side view of the projection system 900. In the present embodiment, a direction parallel to a horizontal direction of the operation surface SS is defined as an X direction, a direction parallel to a vertical direction of the operation surface SS is defined as a Y direction, and a direction parallel to a normal line of the operation surface SS is defined as a Z direction. Further, the lower left position of the operation surface SS in FIG. 2 is defined as the origin (0, 0) of the coordinate (X, Y). It should be noted that in FIG. 3, the range of the projected screen PS out of the screen plate 920 is provided with hatching for the sake of convenience of a graphical description.

The projector 100 has a projection lens 210 for projecting the projected screen PS on the operation surface SS, a first camera 310 for taking an image of the area of the projected screen PS, and a second camera 320 for taking an image of the area of the projected screen PS. The first camera 310 and the second camera 320 take an image with visible light. As shown in FIG. 3, the first camera 310 and the second camera 320 are respectively installed at positions separate in the Z direction from the operation surface SS as much as a length L.

The example shown in FIG. 2 shows the state in which the projection system 900 operates in a whiteboard mode. The whiteboard mode is a mode in which the user can arbitrarily draw a picture on the projected screen PS using the pointing element 70. There is drawn the state in which the tip portion 71 of the pointing element 70 is moved in the projected screen PS to thereby draw a line in the projected screen PS. The translation is performed in the state in which the tip portion 71 of the pointing element 70 has contact with the operation surface SS. The drawing operation of the line is performed by a projection image generation section 500 (described later) incorporated in the projector 100. Further, as described later in detail, the line having been drawn can also be erased using the pointing element 70.

The first camera 310 and the second camera 320 are disposed at the respective positions different from each other, and therefore function as a stereo camera. The first camera 310 and the second camera 320 are disposed at the positions symmetric about the projection lens 210 in the X direction and at the same position in the Y direction and the Z direction in the example of FIG. 2 and FIG. 3, but it is sufficient for the first camera 310 and the second camera 320 to be disposed so as to function as the stereo camera.

It should be noted that the projection system 900 can operate in other modes than the whiteboard mode. For example, this projection system 900 can also operate in a PC interactive mode in which an image of the data having been transferred from a personal computer (not shown) via a communication line is displayed in the projected screen PS. In the PC interactive mode, an image of the data of, for example, spreadsheet software is displayed, and it becomes possible to perform input, generation, correction, and so on of the data using a variety of tools and icons displayed in the image.

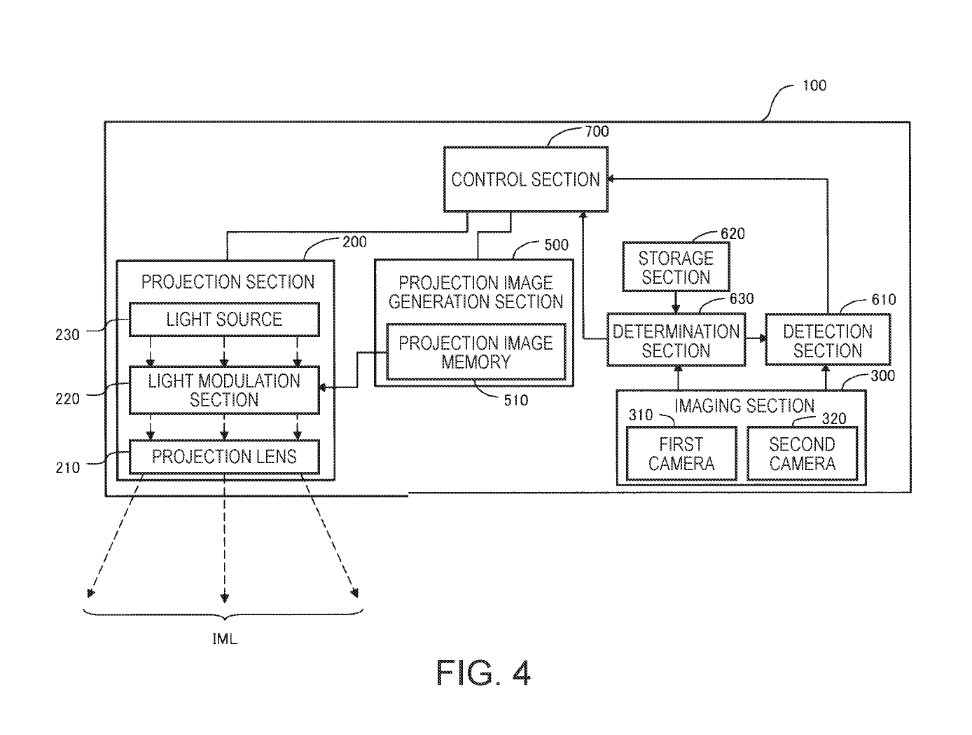

FIG. 4 is a block diagram showing an internal configuration of the projector 100. The projector 100 has a projection section 200, an imaging section 300, a projection image generation section 500, a detection section 610, a storage section 620, a determination section 630, and a control section 700.

The detection section 610 is provided with a processor and a storage medium. The detection section 610 has a function of analyzing the images taken by the first camera 310 and the second camera 320 to determine a 3D position of the pointing element 70. In the determination of the 3D position, there is used the principle of triangulation. In the 3D position of the pointing element 70 determined by the detection section 610, there is included a 3D coordinate of at least nearer one of the tip portion 71 and the rear-end portion 73 to the operation surface SS. Which one of the tip portion 71 and the rear-end portion 73 is nearer to the operation surface SS is determined using the determination result (described later) by the determination section 630.

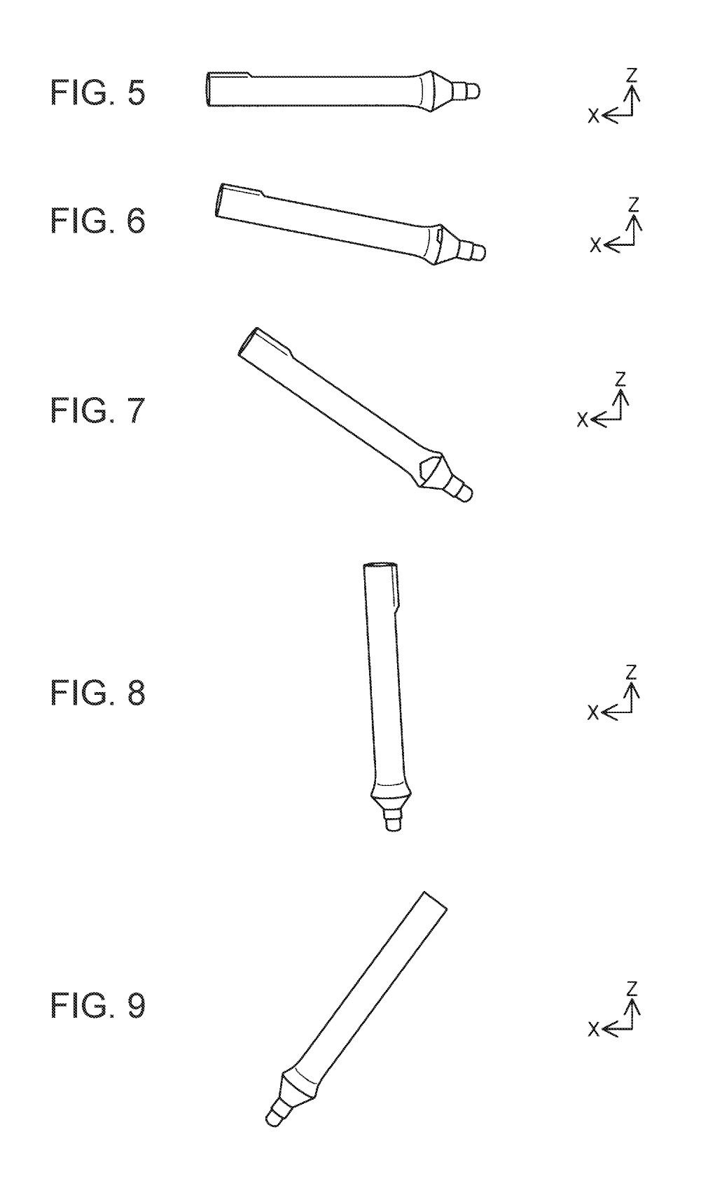

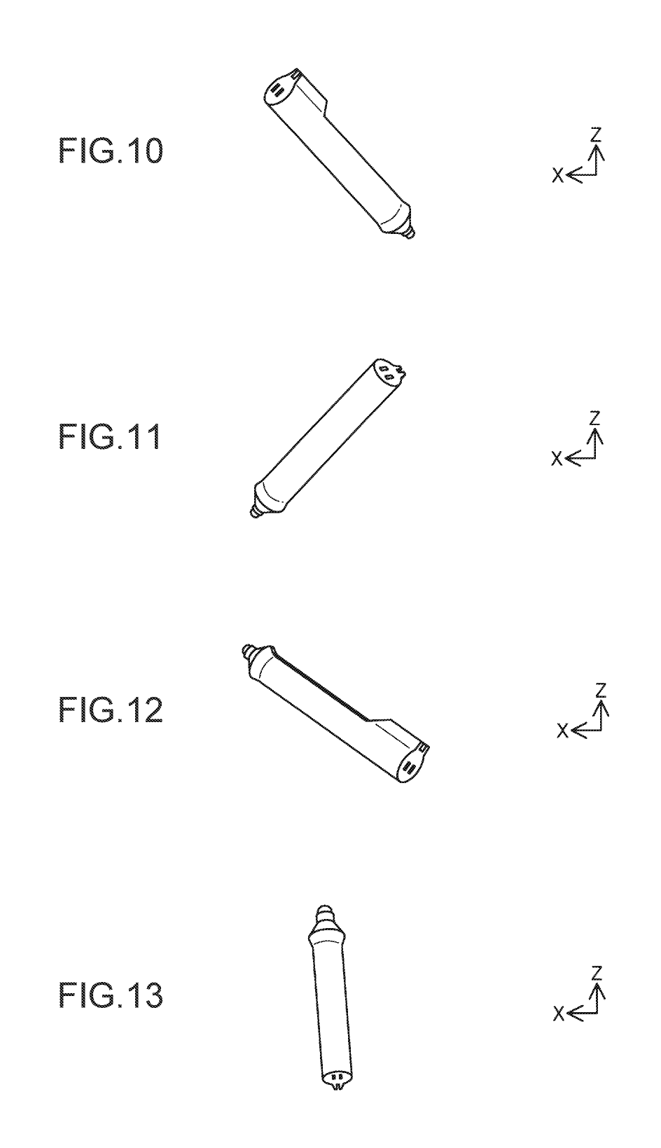

The storage section 620 is a storage medium for storing template images. FIG. 5 through FIG. 13 each illustrate the template image. In the examples shown in FIG. 5 through FIG. 13, the template image is a 2D image in a Z-X plane. The template images are formed by taking the images of the pointing element 70 in a variety of postures with the first camera 310 and the second camera 320 in advance. Further, since the first camera 310 and the second camera 320 are installed at the positions separate in the Z direction from the operation surface SS as much as the length L so as to take the image of the area of the projected screen PS as shown in FIG. 3, the taken images are shifted from the Z-X plane. However, it is also possible to use the taken image as the template image. Further, in the case in which the template images are used in the determination on which one of the tip portion 71 and the rear-end portion 73 of the pointing element 70 is nearer to the operation surface SS, it is sufficient for the storage section 620 to store at least two template images of FIG. 8 and FIG. 12 providing the difference in pattern between the tip portion 71 and the rear-end portion 73 is clear.

To each of the template images, any one of operation modes such as a writing mode, an erasing mode, modes neither the writing mode nor the erasing mode (hereinafter referred to as the other modes) is made to correspond in advance. For example, the writing mode is made to correspond to the template images shown in FIG. 7 through FIG. 11 representing the fact that the tip portion 71 is nearer to the operation surface SS than the rear-end portion 73. Further, the erasing mode is made to correspond to the template images shown in FIG. 12 and FIG. 13 representing the fact that the rear-end portion 73 is nearer to the operation surface SS than the tip portion 71. The other modes are made to correspond to the template images shown in FIG. 5 and FIG. 6.

The correspondence described above is determined based on the positional relationship between the tip portion 71 and the rear-end portion 73. Specifically, if the tip portion 71 is nearer to the operation surface SS than the rear-end portion 73, it is possible to presume that the user attempts to perform writing, and therefore, the writing mode is made to correspond to the template images. In contrast, if the rear-end portion 73 is nearer to the operation surface SS than the tip portion 71, it is possible to presume that the user attempts to perform erasing, and therefore, the erasing mode is made to correspond to the template images. If the tip portion 71 and the rear-end portion 73 are at roughly the same distance from the operation surface SS, it is possible to presume that the user attempts to perform neither writing nor erasing, and therefore, the other modes are made to correspond to the template images.

The determination section 630 is provided with a processor and a storage medium. The determination section 630 determines the operation mode based on the imaging result by the imaging section 300 and the template images stored in the storage section 620. In other words, the determination section 630 performs a matching check between each of the taken images by the first camera 310 and the second camera 320 and the template images to select the best-matched template image. The determination section 630 selects the template image to thereby determine the operation mode. The determination section 630 inputs information representing the operation mode thus determined to the detection section 610 and the control section 700.

When the information representing the fact that the operation mode is the writing mode is input, the detection section 610 detects the 3D position of the tip portion 71. When the information representing the fact that the operation mode is the erasing mode is input, the detection section 610 detects the 3D position of the rear-end portion 73. When the information representing the fact that the operation mode is one of the other modes is input, the detection section 610 does not perform the detection of the 3D position. The detection section 610 inputs the 3D position thus detected to the control section 700.

The control section 700 is provided with a processor and a storage medium. The control section 700 performs control of each of the sections incorporated in the projector 100. The control section 700 determines the content of the instruction executed on the projected screen PS in accordance with the 3D position input from the detection section 610 and the information representing the operation mode input from the determination section 630, and at the same time commands the projection image generation section 500 to generate or change the projection image in accordance with the content of the instruction.

For example, if the control section 700 receives the input of the information representing the writing mode, and if the distance in the Z direction between the 3D position of the tip portion 71 and the operation surface SS is equal to or shorter than a predetermined distance, the control section 700 makes the projection image generation section 500 perform the drawing at the position of (X, Y) included in the 3D position of the tip portion 71. Even in the case in which the control section 700 has received the input of the information representing the writing mode, if the distance in the Z direction between the 3D position of the tip portion 71 and the operation surface SS is longer than the predetermined distance described above, the control section 700 does not make the projection image generation section 500 perform the drawing. The same applies to the case of the erasing mode.

The projection image generation section 500 has a projection image memory 510 for storing the projection image, and has a function of generating the projection image to be projected on the operation surface SS by the projection section 200. It is preferable for the projection image generation section 500 to be further provided with a function as a keystone distortion correction section for correcting a keystone distortion of the projected screen PS.

The projection section 200 has a function of projecting the projection image having been generated by the projection image generation section 500 on the operation surface SS. The projection section 200 has a light modulation section 220 and a light source 230 besides the projection lens 210 explained with reference to FIG. 3. The light modulation section 220 modulates the light from the light source 230 in accordance with the projection image data supplied from the projection image memory 510 to thereby form projection image light IML. The projection image light IML is color image light including the visible light of three colors of RGB, and is projected on the operation surface SS by the projection lens 210. It should be noted that as the light source 230, there can be adopted a variety of types of light sources such as a light emitting diode besides a light source lamp such as a super-high pressure mercury lamp. The light emitting diode can also be a laser diode. Further, as the light modulation section 220, there can be adopted a transmissive or reflective liquid crystal panel, a digital mirror device, and so on, and there can also be adopted a configuration provided with a plurality of light modulation sections 220 for the respective colored light beams.

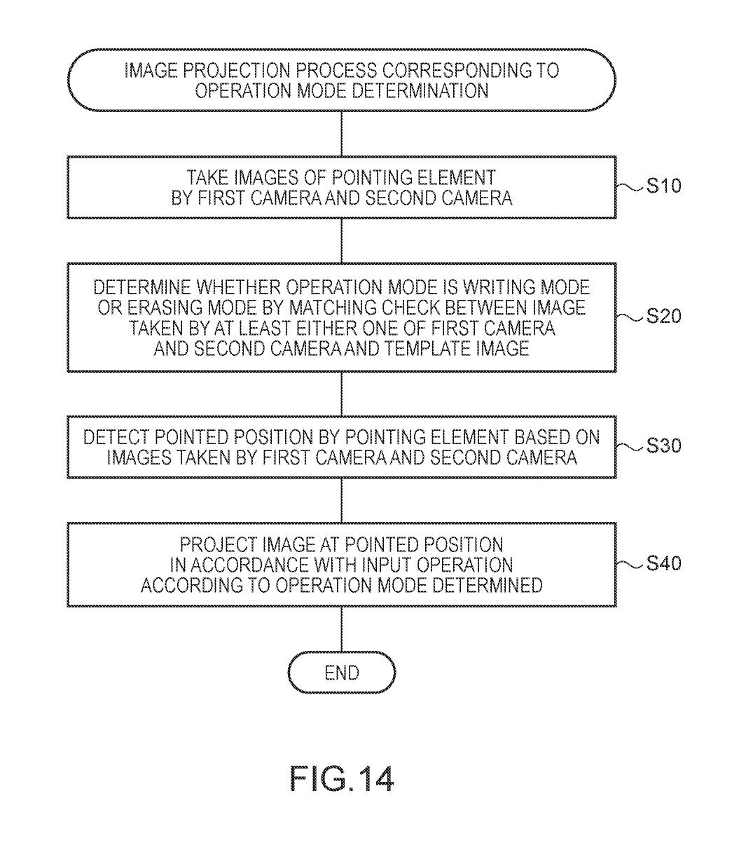

FIG. 14 shows an example of a flowchart of an image projection process corresponding to the operation mode determination.

According to the present embodiment described hereinabove, it becomes easy for the user to perform the selection between the writing mode, the erasing mode, and the other modes than the writing mode and the erasing mode, and it becomes easy for the user to intuitively figure out the operation mode.

The present disclosure is not limited to the present embodiment, but can be implemented with a variety of configurations within the scope or the spirit of the disclosure. For example, the technical features in the embodiment corresponding to the technical features in the aspects described in SUMMARY section can appropriately be replaced or combined in order to solve some or all of the problems described above, or in order to achieve some or all of the advantages. The technical feature can arbitrarily be eliminated unless described in the present embodiment as an essential element. For example, the following embodiments can be illustrated.

It is also possible to perform the matching check between either one of the taken image by the first camera 310 and the taken image by the second camera 320 and the template images. In this case, it is preferable to use the template images based on the images taken by each of the first camera 310 and the second camera 320.

It is also possible for the pointing element 70 to be provided with a light emitting function.

In the embodiment described above, some or all of the functions and the processes realized by software can also be realized by hardware. Further, some or all of the functions and the processes realized by hardware can also be realized by software. As the hardware, it is possible to use a variety of circuits such as an integrated circuit, a discrete circuit, or a circuit module having an integrated circuit and a discrete circuit combined with each other.

The entire disclosure of Japanese Patent Application No.2017-239555, filed Dec. 14, 2017 is expressly incorporated by reference herein.

What is claimed is:

1. An interactive projection system comprising:
a pointing element having a first end portion which is one end portion in a longitudinal direction and is used for a writing mode, and a second end portion which is the other end portion and is used for an erasing mode;
a projection section adapted to project an image on a screen surface in accordance with an input operation using the pointing element;
a first camera adapted to take an image of the pointing element;
a second camera disposed at a different position from a position of the first camera, and adapted to take an image of the pointing element;
a detection section adapted to detect a position on the screen surface pointed by either one of the first end portion and the second end portion based on the image taken by the first camera and the image taken by the second camera;
a storage section adapted to store a template image used to determine a posture of the pointing element to the screen surface; and
a determination section adapted to determine whether an operation mode by the pointing element is the writing mode or the erasing mode based on a matching check between the image taken by at least either one of the first camera and the second camera and the template image stored in the storage section.

2. The interactive projection system according to claim 1, wherein
the determination section determines whether the operation mode by the pointing element is the writing mode or the erasing mode based on the images taken by the first camera and the second camera.

3. The interactive projection system according to claim 1, wherein
the determination section determines whether the operation mode by the pointing element is the writing mode or the erasing mode based on the positional relationship between the first end portion and the second end portion.

4. The interactive projection system according to claim 1, wherein
the detection section detects the 3D position of the first end portion When the operation mode by the pointing element is the writing mode, and
the detection section detects the 3D position of the second end portion when the operation mode by the pointing element is the erasing mode.

5. The interactive projection system according to claim 1, further comprising:
a projection image generation section adapted to:
perform drawing for writing when the distance between the first end portion and the screen surface is equal to or shorter than a predetermined distance in the case of the writing mode, and
perform drawing for erasing when the distance between the second end portion and the screen surface is equal to or shorter than a predetermined distance in the case of the erasing mode.

6. An interactive projector comprising:
a projection section adapted to project an image on a screen surface in accordance with an input operation using a pointing element having a first end portion which is one end portion in a longitudinal direction and is used for a writing mode, and a second end portion which is the other end portion and is used for an erasing mode;
a first camera adapted to take an image of the pointing element;
a second camera disposed at a different position from a position of the first camera, and adapted to take an image of the pointing element;
a detection section adapted to detect a position pointed on the screen surface by either one of the first end portion and the second end portion based on the images taken by the first camera and the second camera;
a storage section adapted to store a template image used to determine a posture of the pointing element to the screen surface; and
a determination section adapted to determine whether an operation mode by the pointing element is the writing mode or the erasing mode based on a matching check between the image taken by at least either one of the first camera and the second camera and the template image stored in the storage section.

7. The interactive projector according to claim 6, wherein
the determination section determines whether the operation mode by the pointing element is the writing mode or the erasing mode based on the images taken by the first camera and the second camera.

8. The interactive projector according to claim 6, wherein
the determination section determines whether the operation mode by the pointing element is the writing mode or the erasing mode based on the positional relationship between the first end portion and the second end portion.

9. The interactive projector according to claim 6, wherein
the detection section detects the 3D position of the first end portion When the operation mode by the pointing element is the writing mode, and
the detection section detects the 3D position of the second end portion when the operation mode by the pointing element is the erasing mode.

10. The interactive projector according to claim 6, further comprising:
a projection image generation section adapted to:
perform drawing for writing when the distance between the first end portion and the screen surface is equal to or shorter than a predetermined distance in the case of the writing mode, and
perform drawing for erasing when the distance between the second end portion and the screen surface is equal to or shorter than a predetermined distance in the case of the erasing mode.

11. A method of controlling an interactive projector, the method comprising:
taking images of a pointing element having a first end portion as one end portion in a longitudinal direction and a second end portion as the other end portion using a first camera and a second camera disposed at a different position from a position of the first camera;
detecting a pointed position pointed on a screen surface by either one of the first end portion and the second end portion based on the images taken by the first camera and the second camera; and
determining whether an operation mode by the pointing element is a writing mode or an erasing mode based on a matching check between the image taken by at least either one of the first camera and the second camera and a template image used to determine a posture of the pointing element to the screen surface.

12. The method of controlling the interactive projector according to claim 11, wherein
determining whether the operation mode by the pointing element is the writing mode or the erasing mode based on the images taken by the first camera and the second camera.

13. The method of controlling the interactive projector according to claim 11, wherein
determining whether the operation mode by the pointing element is the writing mode or the erasing mode based on the positional relationship between the first end portion and the second end portion.

14. The method of controlling the interactive projector according to claim 11, wherein
detecting the 3D position of the first end portion When the operation mode by the pointing element is the writing mode, and
detecting the 3D position of the second end portion when the operation mode by the pointing element is the erasing mode.

15. The method of controlling the interactive projector according to claim 11, further comprising:
performing drawing for writing when the distance between the first end portion and the screen surface is equal to or shorter than a predetermined distance in the case of the writing mode, and
performing drawing for erasing when the distance between the second end portion and the screen surface is equal to or shorter than a predetermined distance in the case of the erasing mode.
